(19) United States
(12) Patent Application Publication
(10) Pub. No.: US 2020/0323184 A1
(43) Pub. Date: Oct. 15, 2020

(54) FISHING HOOK HAVING FLEXIBLE EYE

(71) Applicant: Savage Gear Americas, Inc., Miramar, FL (US)

(72) Inventors: Jose Chavez, Tampa, FL (US); Mads Grosell, Copenhagen (DK)

(73) Assignee: Savage Gear Americas, Inc., Miramar, FL (US)

(21) Appl. No.: 16/379,326

(22) Filed: Apr. 9, 2019

(51) Int. Cl. A01K 83/00

(52) U.S. Cl. CPC A01K 83/00

(57) ABSTRACT

A fishing hook includes a shank having a first end and an opposing second end, a plurality of bends extending from the opposing second end of the shank, and an eye coupled to the first end of the shank. Each of the plurality of bends terminates with a point and a barb. The shank and the plurality of bends are manufactured from a first material. The eye forms a loop (i) extending directly from the first end of the shank and (ii) defining an aperture. The eye is manufactured from a second material that is different than the first material.

### TECHNICAL FIELD

The present application relates to fishing hooks.

### BACKGROUND

Fishing hooks for fishing lures traditionally have rigid eyes that only allow limited rotation of the fishing hooks relative to an attachment point of the fishing lures. Such limited rotation allows fish to rotate the fishing hooks to a fixed position. The fish can then use the leverage from the fixed hook to pry the hook loose from their mouth.

### SUMMARY

One embodiment relates to a fishing hook. The fishing hook includes a shank having a first end and an opposing second end, a plurality of bends extending from the opposing second end of the shank, and an eye coupled to the first end of the shank. Each of the plurality of bends terminates with a point and a barb. The shank and the plurality of bends are manufactured from a first material. The eye forms a loop (i) extending directly from the first end of the shank and (ii) defining an aperture. The eye is manufactured from a second material that is different than the first material.

Another embodiment relates to a fishing lure. The fishing lure includes a body having an attachment point and a hook coupled to the attachment point. The hook includes a shank having a first end and an opposing second end, a plurality of bends extending from the opposing second end of the shank, and an eye coupled to the first end of the shank. Each of the plurality of bends terminates with a point and a barb. The eye forms a loop (i) extending from the first end of the shank and (ii) defining an aperture that couples the hook to the attachment point. The eye facilitates rotation of the hook about a longitudinal axis of the hook relative to the attachment point up to at least one full rotation.

Still another embodiment relates to a fishing hook. The fishing hook includes a shank having a first end and an opposing second end, a plurality of bends extending from the opposing second end of the shank, and an eye coupled to the first end of the shank. Each of the plurality of bends terminates with a point and a barb. The shank and the plurality of bends are manufactured from a rigid material. The eye forms a loop extending directly from the first end of the shank and configured to facilitate coupling the fishing hook to an attachment point of a lure. The eye is manufactured from a flexible material that facilitates rotation of the fishing hook about a longitudinal axis of the fishing hook relative to the attachment point up to at least one full rotation. The fishing hook has an overall dimension and the eye has an eye dimension. A ratio of the eye dimension to the overall dimension is at most 1:3. The shank and the plurality of bends are incapable of passing through the eye.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a lure having a plurality of hooks, according to an exemplary embodiment.

FIG. 2 is a perspective view of a first hook useable with the lure of FIG. 1, according to an exemplary embodiment.

FIG. 3 is a perspective view of a second hook useable with the lure of FIG. 1, according to an exemplary embodiment.

FIG. 4 is a side view of the first hook of FIG. 2.

FIG. 5 is a detailed view of an eye of the first hook of FIG. 4.

FIG. 6 is a detailed view of a rotational mechanism useable with the plurality of hooks of the fishing lure of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a fishing hook having two or more bends (e.g., a double hook, a treble hook, etc.) has a flexible eye that facilitates increased rotation of the fishing hook when attached to a lure relative to a fishing hook having a rigid eye. Advantageously, such increased rotation prevents the fishing hook from becoming rotationally fixed and, therefore, eliminates any leverage that a fish could otherwise utilize to pry the fishing hook from their mouth. Accordingly, the fishing hook of the present disclosure may drastically decrease the number of fish that “throw” or “shake” the fishing hook, thereby increasing the number of fish capable of being caught. Also, such increased rotation may minimize the frequency at which the fishing hook becomes “snagged” on something in the water (e.g., twigs, logs, the floor of a body of water, seaweed, debris, rubbish, etc.). Further, in some embodiments, the dimensions of the hook of the present disclosure are selected such that it is impossible for ends (e.g., points, barbs, etc.) of the fishing hook to engage with the eye of the fishing hook or a hook attachment point on the lure. In an alternative embodiment, the flexible eye is replaced with a rigid eye that is rotationally coupled to the remainder of the hook (e.g., a shank of the hook, etc.).

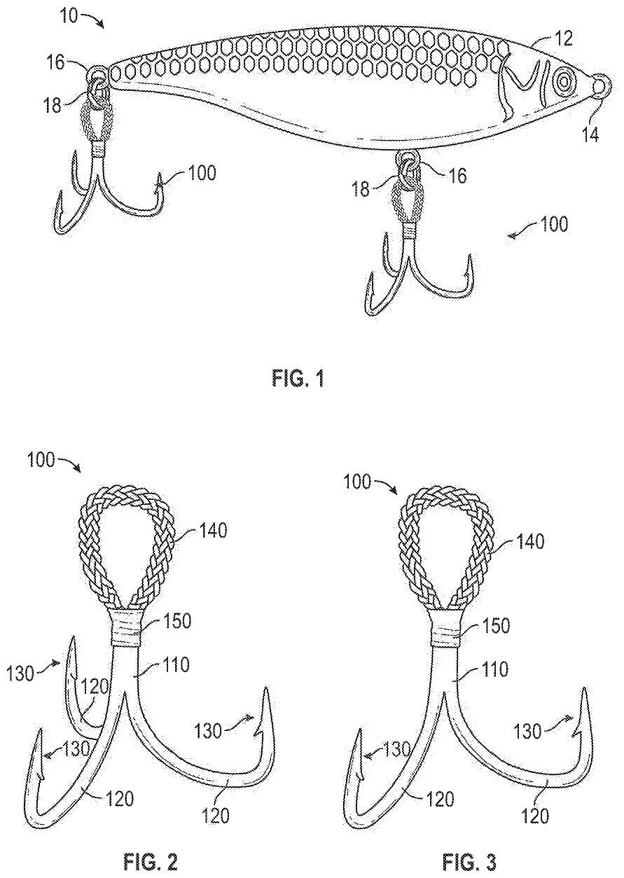

According to the exemplary embodiment shown in FIGS. 1-6, a lure, shown as fishing lure 10, includes a plurality of hooks, shown as fishing hooks 100, coupled thereto that are configured to rotate up to at least one full rotation (e.g., at least 360 degrees, more than 360 degrees, at least 720 degrees, etc.) relative to a portion (e.g., an attachment point, etc.) of the fishing lure 10. As shown in FIG. 1, the fishing lure 10 includes a body, shown as lure body 12. The lure body 12 has a first attachment point (e.g., a metal ring, etc.), shown as line attachment point 14, disposed at a front end of the lure body 12 and a plurality of second attachment points (e.g., metal rings, etc.), shown as hook attachment points 16, positioned along the lure body 12 (e.g., along the bottom thereof, at the rear end thereof, etc.). In other embodiments, the line attachment point 14 and/or the hook attachment points 16 are otherwise positioned about the lure body 12. As shown in FIG. 1, the fishing lure 10 includes two of the hook attachment points 16 and a corresponding number of the fishing hooks 100. In some embodiments, the fishing lure 10 includes only one of the hook attachment points 16 and only one of the fishing hooks 100. In some embodiments, the fishing lure 10 includes three or more of the hook attachment points 16 and a corresponding number of the fishing hooks 100. As shown in FIG. 1, the fishing lure 10 includes a plurality of intermediate couplers, shown as split rings 18, with one of the split rings 18 (i) coupled (e.g., attached, secured, etc.) to each of the hook attachment points 16 and (ii) coupled to a respective one of the fishing hooks 100 to couple the fishing hooks 100 to the hook attachment points 16. In other embodiments, the fishing hooks 100 are directly coupled to the hook attachment points 16 (i.e., without the split rings 18).

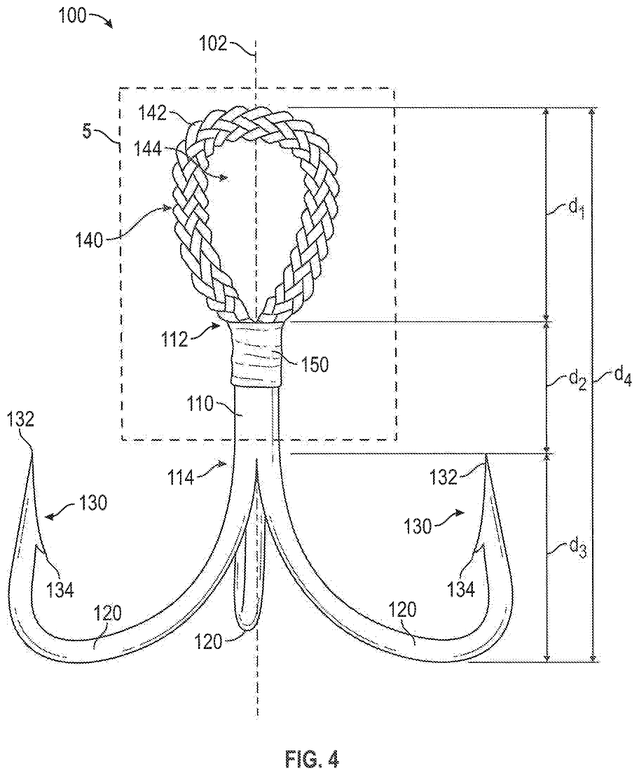

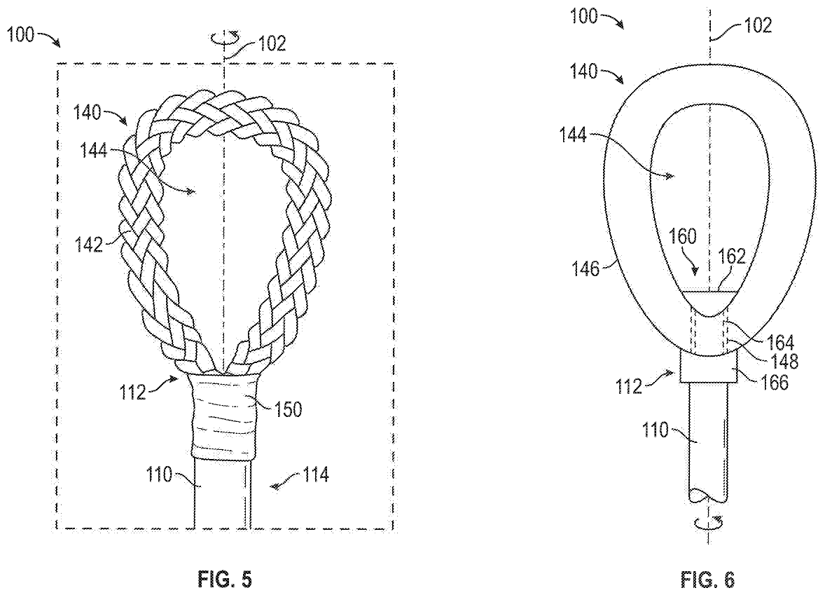

As shown in FIGS. 2-5, each of the fishing hooks 100 includes an elongated shaft, shown as shank 110, having a first end, shown as top end 112, and an opposing second end, shown as bottom end 114; a plurality of bends, shown as bends 120, extending from the bottom end 114 of the shank 110; and an eye, shown as hook eye 140, coupled to the top end 112 of the shank 110 at an interface, shown as coupling interface 150. As shown in FIGS. 4 and 5, the shank 110 defines a central axis, shown as longitudinal axis 102, of the fishing hook 100. As shown in FIGS. 2-4, the bends 120 extend downward from the bottom end 114 of the shank 110 and curve upward with ends thereof terminating with a hooking element, shown as hook end 130, having a point 132 and a barb 134. The bottom end 114 of the shank 110 is defined as starting at the point where the bends 120 separate from the shank 110 such that cleavage is formed (and then moving downward). As shown in FIGS. 2 and 4, the fishing hook 100 has three bends 120 extending in different directions (e.g., spaced 120 degrees apart relative to one another, etc.) such that the fishing hook 100 is configured as a treble hook. As shown in FIG. 3, the fishing hook 100 has two bends 120 extending in different directions such that the fishing hook 100 is configured as a double hook. In some embodiments, the fishing hook 100 has four bends 120. According to an exemplary embodiment, the shank 110 and the bends 120 are integrally formed and are manufactured from a first, rigid material (e.g., metal, high-carbon steel, steel alloys, stainless steel, etc.).

As shown in FIGS. 4 and 5, the hook eye 140 forms a first loop, shown as flexible loop 142, that (i) extends directly from the top end 112 of the shank 110 and (ii) defines an aperture, shown as eyelet 144, that engages with a respective one of the split rings 18 and/or the hook attachment points 16 to secure the fishing hook 100 to the lure body 12. According to various exemplary embodiment, the ends of the flexible loop 142 are secured to the coupling interface 150 via a tying process, a cinching process, a welding process, a threading process, and/or still another suitable coupling process.

According to an exemplary embodiment, the flexible loop 142 is manufactured from a second, flexible material that is different than the first, rigid material of the shank 110 and the bends 120. In some embodiments, the second, flexible material is a braided line. Such a braided line may include a plurality of fabric strands or fibers braided together to form the second, flexible material. The braided line may be manufactured from materials commonly known as Spectra, Dyneema, Kevlar, Dacron, and/or still another suitable fabric or fiber material. In some embodiments, the second, flexible material is a cable. Such a cable may include a plurality of metal wires or strands twisted together to form the second, flexible material. The cable may be manufactured from stainless steel, nickel-titanium, and/or still another suitable metallic material. In some embodiments, the second, flexible material is a monofilament or fluorocarbon. Such a monofilament or fluorocarbon may be manufactured from a plastic material, polyvinylidene fluoride, and/or still another suitable material.

According to an exemplary embodiment, the second, flexible material of the hook eye 140 facilitates rotation of the shank 110 of the fishing hook 100 about the longitudinal axis 102 relative to the hook attachment point 16. Specifically, the second, flexible material of the hook eye 140 stretches, twists, and/or otherwise deforms to permit increased rotation of the fishing hook 100 relative to traditional hooks having rigid eyes. In some embodiments, the hook eye 140 facilitates up to at least one full rotation of the shank 110 about the longitudinal axis 102. In some embodiments, the hook eye 140 facilitates between one and two full rotations of the shank 110 about the longitudinal axis 102. In particular embodiments, the hook eye 140 facilitates more than two full rotations of the shank 110 about the longitudinal axis 102 (e.g., the hook eye 140 is manufactured from a relatively “stretchy” material, the hook eye 140 has dimensions suitable for more than two full rotations, etc.).

As shown in FIG. 4, the fishing hook 100 has a first length, shown as eye dimension d₁; a second length, shown as shank dimension d₂; a third length, shown as bend dimension d₃; and a fourth length, shown as overall dimension d₄ that extends along the longitudinal axis 102 and defined by the eye dimension d₁, the shank dimension d₂, and the bend dimension d₃. The eye dimension d₁ is the distance between the top end 112 of the shank 110 to the top of the hook eye 140. The shank dimension d₂ is the distance between the top end 112 and the bottom end 114 of the shank 110. The bend dimension d₃ is the distance between the bottom end 114 of the shank 110 (i.e., the point where the cleavage is formed) to the lowermost point of the bends 120.

According to various embodiments, the overall dimension d₄ of the fishing hook 100 is between 10 millimeters (“mm”) and 220 mm. The eye dimension d₁, the shank dimension d₂, and/or the bend dimension d₄ may vary based on the overall dimension d₄ of the fishing hook 100. The eye dimension d₁ may range from 2 mm to 30 mm. The shank dimension d₂ may range from 3 mm to 120 mm. The bend dimension d₃ may range from 3 mm to 120 mm. In other embodiments, the eye dimension d₁, the shank dimension d₂, and/or the bend dimension d₃ vary from the aforementioned ranges. According to an exemplary embodiment, the eye dimension d₁, the shank dimension d₂, and the bend dimension d₃ are selected such that the point 132 and the barb 134 are incapable of engaging the eyelet 144 of the hook eye 140 and the hook attachment point 16 of the lure 10 and, therefore, (i) the hook ends 130 cannot get stuck in the eyelet 144 or the hook attachment point 16 nor (ii) can the bends 120 and the shank 110 pass through the hook eye 140.

In some embodiments, the eye dimension d₁, the shank dimension d₂, and the bend dimension d₃ are selected such that a ratio of the eye dimension d₁ to the overall dimension d₄ is at most 1:2 (i.e., the eye dimension d₁ is at most one-half the overall dimension d₄). In some embodiments, the eye dimension d₁, the shank dimension d₂, and the bend dimension d₃ are selected such that a ratio of the eye dimension d₁ to the overall dimension d₄ is at most 1:3. In some embodiments, the eye dimension d₁, the shank dimension d₂, and the bend dimension d₃ are selected such that a ratio of the eye dimension d₁ to the overall dimension d₄ is at most 1:4. In some embodiments, the eye dimension d₄, the shank dimension d₂, and the bend dimension d₃ are selected such that a ratio of the eye dimension d to the overall dimension d₄ is at most 1:5 (e.g., 1:5, 1:6, 1:7, 1:8, 1:9, etc.). In some embodiments, the eye dimension d₁, the shank dimension d₂, and the bend dimension d₃ are selected such that a ratio of the eye dimension d₁ to the overall dimension d₄ is at most 1:10.

FIG. 6 is a detailed view of a rotational mechanism useable with the plurality of hooks of the fishing lure of FIG. 1, according to an exemplary embodiment. As shown in FIG. 6, the fishing hook 100 does not include the flexible loop 142, rather, the hook eye 140 forms a second loop, shown as rigid loop 146. According to an exemplary embodiment, the rigid loop 146 is manufactured from a third, rigid material. The third, rigid material of the rigid loop 146 may be the same as or different than the first, rigid material of the shank 110 and the bends 120. As shown in FIG. 6, the fishing hook 100 includes a rotational element, shown as rotational coupler 160, positioned to rotationally couple the hook eye 140 and the shank 110 together. According to an exemplary embodiment, the rotational coupler 160 facilitates an infinite number of rotations of the shank 110 relative to the hook eye 140 about the longitudinal axis 102. As shown in FIG. 6, the rotational coupler 160 includes a first retainer, shown as retainer 162, positioned along an interior periphery of the rigid loop 146; an extension, shown as rotational shaft 164, having a first end coupled to the retainer 162 and extending through a passage, shown as passage 148, defined by the rigid loop 146; and a second retainer, shown as retainer 166, (i) positioned along an outer periphery of the rigid loop 146 and (ii) coupled between an opposing second end of the rotational shaft 164 and the top end 112 of the shank 110. In other embodiments, another type of rotational coupling is formed between the rigid loop 146 and the shank 110 to facilitate the rotation of the shank 110 relative to the hook eye 140.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the fishing lure 10 and the fishing hook 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A fishing hook comprising:
a shank having a first end and an opposing second end;
a plurality of bends extending from the opposing second end of the shank, each of the plurality of bends terminating with a point and a barb, the shank and the plurality of bends manufactured from a first material; and
an eye coupled to the first end of the shank, the eye forming a loop (i) extending directly from the first end of the shank and (ii) defining an aperture, the eye manufactured from a second material that is different than the first material.

2. The fishing hook of claim 1, wherein the first material is a rigid material and the second material is a flexible material.

3. The fishing hook of claim 2, wherein the flexible material is a braided line.

4. The fishing hook of claim 3, wherein the braided line includes a plurality of braided fibers.

5. The fishing hook of claim 2, wherein the flexible material is a cable.

6. The fishing hook of claim 5, wherein the cable is manufactured from a plurality of metal wires.

7. The fishing hook of claim 2, wherein the flexible material is at least one of a monofilament or fluorocarbon.

8. The fishing hook of claim 2, wherein the flexible material facilitates rotation of the fishing hook about a longitudinal axis of the fishing hook relative to an attachment point of a lure up to at least one full rotation.

9. The fishing hook of claim 1, wherein the eye is coupled to the first end of the shank via at least one of tying, cinching, welding, or threading.

10. The fishing hook of claim 1, wherein the fishing hook has an overall dimension and the eye has an eye dimension, wherein a ratio of the eye dimension to the overall dimension is at most 1:2.

11. The fishing hook of claim 10, wherein the ratio is at most 1:3.

12. The fishing hook of claim 11, wherein the ratio is at most 1:4.

13. The fishing hook of claim 12, wherein the ratio is at most 1:5.

14. The fishing hook of claim 1, wherein the point and the barb are incapable of engaging the aperture of the eye, and wherein the shank and the plurality of bends are incapable of passing through the eye.

15. A fishing lure comprising:
a body having an attachment point; and
a hook coupled to the attachment point, the hook including:
a shank having a first end and an opposing second end;
a plurality of bends extending from the opposing second end of the shank, each of the plurality of bends terminating with a point and a barb; and
an eye coupled to the first end of the shank, the eye forming a loop (i) extending from the first end of the shank and (ii) defining an aperture that couples the hook to the attachment point, the eye facilitates rotation of the hook about a longitudinal axis of the hook relative to the attachment point up to at least one full rotation.

16. The fishing lure of claim 15, wherein the eye is manufactured from a flexible material.

17. The fishing lure of claim 16, wherein the flexible material is at least one of a braided line, a cable, a monofilament, or fluorocarbon.

18. The fishing lure of claim 15, wherein the point and the barb are incapable of engaging the aperture of the eye or the attachment point of the body, and wherein the shank and the plurality of bends are incapable of passing through the eye.

19. A fishing hook comprising:
a shank having a first end and an opposing second end;
a plurality of bends extending from the opposing second end of the shank, each of the plurality of bends terminating with a point and a barb, the shank and the plurality of bends manufactured from a rigid material; and
an eye coupled to the first end of the shank, the eye forming a loop extending directly from the first end of the shank and configured to facilitate coupling the fishing hook to an attachment point of a lure, the eye manufactured from a flexible material that facilitates rotation of the fishing hook about a longitudinal axis of the fishing hook relative to the attachment point up to at least one full rotation;
wherein the fishing hook has an overall dimension and the eye has an eye dimension, wherein a ratio of the eye dimension to the overall dimension is at most 1:2; and
wherein the shank and the plurality of bends are incapable of passing through the eye.

20. The fishing hook of claim 19, wherein the ratio of the eye dimension to the overall dimension is at most 1:3.
